(19) United States
(12) Patent Application Publication
(10) Pub. No.: US 2002/0032660 A1
(43) Pub. Date: Mar. 14, 2002

(54) Postage meter machine and security module therefor

(76) Inventors: Klaus Dietrich, Berlin (DE); Michael Sperling, Berlin (DE)

Correspondence Address: SCHIFF HARDIN & WAITE, Patent Department, 7100 Sears Tower - 233 South Wacker Drive, Chicago, IL, 60606, US

(21) Appl. No.: 09/768,699

(22) Filed: Jan. 24, 2001

(30) Foreign Application Priority Data
Jan. 27, 2000 (DE) 100 03 310.5

(51) Int. Cl. G06F 17/60

(52) U.S. Cl. 705/60

(57) ABSTRACT

A postage meter machine for franking postal matter has a printer for printing a postage value stamp on the postal matter, a control unit for controlling the printing and peripheral components of the postage meter machine, and a security module for debiting postage fee data. In order to prevent manipulations, unauthorized use and unauthorized copying of control software, the control unit is authorized by multiple, automatic interrogations and handovers of a security code from the control unit to the security module. The security module is deactivated given an incorrect security code or the lack of a handover of the security code. Accounting and franking are thus no longer possible in the deactivated condition.

### BACKGROUND OF THE INVENTION

1. Field of the Invention

The present invention is directed to a security module for a postage meter machine for protecting postage fee data against unauthorized use and manipulation, as well as to a postage meter machine employing such a security module.

2. Description of the Prior Art

A postage meter machine of the above type is known, for example, from European Application 789 333. This is equipped with a printer for printing the postage value stamp on postal matter, a central controller for controlling the printing and peripheral components of the postage meter machine, an accounting unit for debiting postage fees that are maintained in non-volatile memories, and a unit for cryptographically securing the postage fee data. The accounting unit and/or the unit for securing the printing of the postage fee data can be realized with a security module.

For protecting the security module, it is known to design the module such that it can be programmed only a single time and such that sensitive data are stored therein protected against readout. For protection against manipulations, the module can be encapsulated by a security housing or critical components of the security module can be cast in casting compound. Security modules for postage meter machines can be realized as multi-chip modules or as one-chip systems (for example, chip cards). Structurally, they are either rigidly connected to the postage meter machine or are luggable. The postage meter machine can be realized as a stand-alone device or as a conventional computer with a specific software and, as needed, additional hardware components.

It is necessary in postage meter machines to take particular protective measures against unauthorized use of the postage meter machine and against any and all manipulations. Particularly given franking machines realized by a conventional computer, illegally duplicating the specific software employed and installing and using it on another computer must also be prevented.

### SUMMARY OF THE INVENTION

An object of the present invention is to provide a postage meter machine equipped with special protective measures.

The above object is achieved in accordance with the principles of the present invention in a postage meter machine for franking postal items having a printer for printing a postage value stamp (imprint) on the postal items, a control unit for controlling the printing as well as for controlling peripheral components of the postage meter machine, and having a security module for debiting postage fee data, wherein the security module automatically, multiply interrogates the control unit during the operation of the postage meter machine to compel, upon each interrogation, a handover of a security code from the control unit to the security module. The security module deactivates itself, thereby deactivating operation of the postage mister machine, if the control unit hands over an incorrect security code or fails to handover a security code.

The invention is based on the recognition that an unallowed copying of software, and operation with other hardware, can be prevented by providing specific software that can only be operated together with a specific hardware, i.e. the combination represents one highly specific device. In the context of a postage meter machine, this means that the postage meter machine is inventively fashioned such that it can only be operated (in particular, critical functions such as the debiting of postage fee data and the production of frankings can only be implemented) when an authorization of the control unit ensues at the security module by interrogating and handing over a declared security code. Inventively, this authorization ensues automatically and without action on the part of the user, to whom the procedure is not noticeable. It is thereby assured that a security module can be operated exclusively with a control unit specifically authorized therefor. The invention does not permit the same security module to be operated with a different control unit, for example if the controller software of a postage meter machine were copied in unauthorized fashion and operated on a different franking machine, for example on a different computer, since this control cannot authorize itself, or would supply an incorrect security code.

The postage meter machine is thereby inventively configured such that the interrogation and handover of the security code ensues not only once upon commissioning of the postage meter machine, but ensures regularly, i.e. repeatedly and continuously, during operation. In an embodiment, this interrogation can ensue at regular or irregular time intervals, a module computing unit being provided in the security module for this purpose.

The timer provided in the preferred development of the invention serves the purpose of prescribing a time duration within which the control unit must authorize itself at the security module in order to prevent a deactivation of the security module. This time duration either can be fixed once and be constant, or can be individually defined by the user. In order to make manipulations even more difficult, the length of the time duration can be varied and arbitrarily defined by the timer after every authorization, for which purpose the timer includes, for example, a random generator.

Since an incorrect or missing security code need not necessarily mean that a manipulation or unauthorized use of the postage meter machine is ensuing, the security module is configured in a further embodiments so that it can be activated at any time in the deactivated condition by handing over the security code. If, for example, the security code was incapable of being handed over due to a communication malfunction between the control unit and the security module, and the security module was therefore deactivated, an activation can ensue again any time after the communication malfunction has been corrected.

Another embodiment, wherein a code identifies the hardware of the control unit, offers particular protection against unauthorized copying of the control software of the postage meter machine. For example, the machine number of the control unit can thereby be employed as security code; the security module must then also know this.

The handover of the security code from the control unit to the security module can ensue in encrypted form in a further embodiment. This also offers additional protection against manipulations, who may, for example, by tap into the communication between the security module and the control unit in order to acquire the security code.

### DESCRIPTION OF THE DRAWINGS

FIG. 1 is a block circuit diagram of an inventive postage meter machine.

FIG. 2 is a block circuit diagram of the control unit and the security module in the inventive postage meter machine.

### DESCRIPTION OF THE PREFERRED EMBODIMENTS

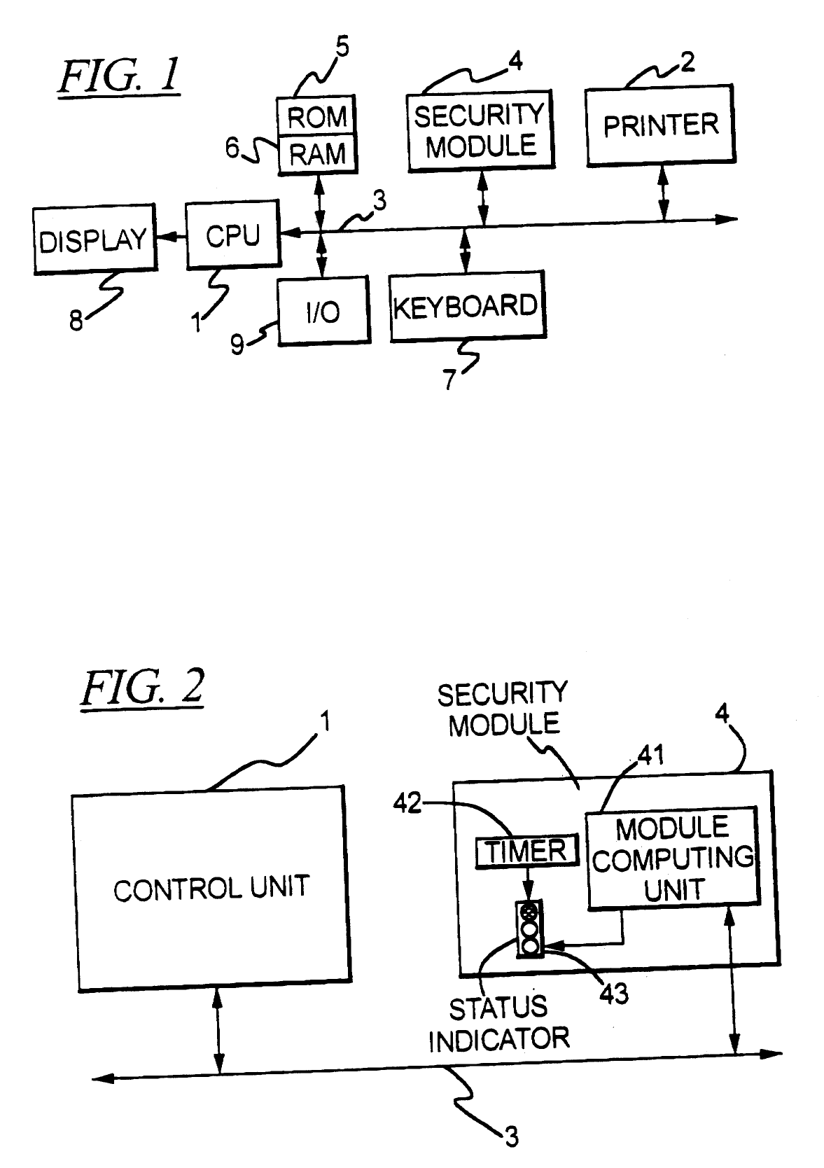

FIG. 1 shows a block circuit diagram of an inventive postage meter machine with the basic function units. A central control unit 1, which is realized by a microprocessor (CPU) in the present case, controls the printing of postage value stamps on postal matter, which ensues with a printer 2. The control unit 1 is connected to a security module 4 and to the printer 2 via a control bus 3 that contains address, data and control lines.

Further, the control unit 1 is connected to a non-volatile memory 5 and to a main memory 6 via the control bus 3. A central control program for the control unit 1 is stored in the memory 5 as a command sequence, as are masters for compiling the print format of the postage value stamp. The control unit 1 loads the desired master into the main memory 6 and processes this according to the inputs of an operator. The desired print format is generated according to these inputs, which also include the input of the postage value, and is stored in the main memory 6.

The user can operate the postage meter machine and, for example, prescribe the print image via a keyboard 7 connected to the control bus 3. A display 8 driven by the control unit 1 informs the user about the executive sequences in the postage meter machine. An input/output unit 9 is connected to drive elements (not shown) of the postage meter machine and to sensors that monitor the status of the postage meter machine. A transport system (not shown) for transporting the postal matter is also be connected to the input/output unit 9.

The security module 4 generally contains an accounting unit (not shown). The accounting unit implements the debiting of postage fees that correspond to the postage value. The aforementioned European Application 789 333 as well as German Utility Model 299 05 219 disclose the detailed structure and functioning of such a known security module.

FIG. 2 shows the control unit 1 and the security module 4 of the inventive postage meter machine, with only the function groups of the security module 4 that are important for the invention being shown. The security module 4 contains a module computing unit 41 that repeatedly compels an authorization of the control unit 1 during the operation of the postage meter machine, to which end it requests the handover of a declared security code from the control unit 1 via the control bus 3. If this authorization does not ensue or ensues incorrectly, for example by handing over an incorrect security code because of a manipulation or a replacement of the control unit 1, the module computing unit 41 switches the security module 4 into a deactivated condition, so that no accounting and no franking of postal matter can ensue. A status indicator 43 is provided for displaying the current status, as disclosed in the aforementioned German Utility Model 299 05 219.

The security module 4 also contains a timer 42 that determines the time intervals at which the module computing unit 41 should interrogate an authorization from the control unit 1 or a time duration since the last authorization after which the security module 4 is automatically deactivated when no new authorization is forthcoming. The timer 42 is thereby configured such that this time duration is variable, i.e. changes after every accomplished authorization, and is randomly determined This additionally contributes to preventing manipulations of the postage meter machine, since a potential manipulator never knows at which time intervals an authorization will be requested from the control unit 1 and how long operation could be carried out with a manipulated control unit. The timer 42 is also configured for deactivating the security module 4 when no authorization is forthcoming from the control unit 1 within the established time duration.

The postage meter machine is configured such that, even in the deactivated condition of the security module 4, the security code can be handed over from the control unit 1 to reactivate the security module 4 without being requested to do so by the module computing unit 41. A code that identifies the hardware of the control unit 1, for example the machine number thereof, preferably serves as security code, this being preferably transmitted via the control bus 3 in encrypted form for security reasons. This security code is also known to the security module 4 and, for example, is stored therein in the module computing unit 41 in order to check whether the security code handed over by the control unit 1 is correct. This security code is preferably defined at the initial commissioning and enabling of the security module 4.

The invention thus prevents the security module 4 from being operated with a control unit 1 other than the one provided for it. Unauthorized copying of the software installed on the control unit 1 and installation thereof on another control unit and operation there at with a different security module is also prevented. Unauthorized duplication of the franking software, referred to as pirated copies, thus can be effectively prevented.

Although modifications and changes may be suggested by those skilled in the art, it is the intention of the inventors to embody within the patent warranted hereon all changes and modifications as reasonably and properly come within the scope of their contribution to the art.

We claim as our invention:

1. A postage meter machine for franking postal items, comprising:
a printer adapted for printing a postage value stamp on a postal item;
a control unit for controlling operation of at least said printer; and
a security module, for debiting postage fee data used for producing said postage value stamp, which must be activated to permit said control unit to control said printer, said security module being electronically connected to said control unit and automatically, multiply interrogating said control unit to require handover of a security code from said control unit to said security module, said security module automatically deactivating itself, and thereby precluding printing of said postage value stamp, if said control unit hands over an incorrect security code or no security code upon each interrogation.

2. A postage meter machine as claimed in claim 1 wherein said security module contains a module computing unit for conducting said multiple interrogations of said control unit, at regular time intervals.

3. A postage meter machine as claimed in claim 1 wherein said security module contains a module computing unit for conducting said multiple interrogations of said control unit, at irregular time intervals.

4. A postage meter machine as claimed in claim 1 wherein said security module contains a timer which deactivates said security module after expiration of a time duration following a last handover of a correct security code from said control module, if a further handover of said correct security code does not occur within said time duration.

5. A postage meter machine as claimed in claim 4 wherein said timer randomly varies said time duration.

6. A postage meter machine as claimed in claim 1 wherein said security module, after deactivation, automatically re-activates itself upon handover of a security code from said control unit to said security module.

7. A postage meter machine as claimed in claim 1 wherein said control unit contains hardware having an identifier code associated therewith., and wherein said control unit and said security module use said hardware identifier code as said security code.

8. A postage meter machine as claimed in claim 1 wherein said control unit encrypts said security code, prior to handing said security code over to said control unit, to form an encrypted security code, and wherein said control unit hands over said encrypted security code to said control unit.

9. In a postage meter machine having a control unit for, controlling printing of a postage value imprint on a postal item, the improvement of a security module, which must be activated to allow controlling of printing by said control unit, comprising:
at least one security module component for automatically, multiply interrogating said control unit to require handover of a security code from said control unit to said security module, and for deactivating said security module if said control unit hands over an incorrect security code or no security code.
